(19) United States
(12) Patent Application Publication
(10) Pub. No.: US 2007/0025714 A1
(43) Pub. Date: Feb. 1, 2007

(54) Image capturing apparatus

(76) Inventor: Hidenori Shiraki, Nagano (JP)

Correspondence Address: Pamela R. Crocker;Patent Legal Staff, Eastman Kodak Company, 343 State Street, Rochester, NY, 14650-2201, US

(21) Appl. No.: 11/305,976

(22) Filed: Dec. 19, 2005

(30) Foreign Application Priority Data
Jul. 29, 2005 (JP) 2005-222091

(51) Int. Cl. G03B 17/00

(52) U.S. Cl. 396/72

(57) ABSTRACT

In a digital camera, control operations, such as an AF (automatic focusing) operation which is performed immediately after zooming or panning of the camera, can be performed quickly in an appropriate manner. When a zoom lens 3 is driven to zoom “up”(“in”), a control processor and timing generator 40 uses, of imaging conditions data, such as distance measuring data and photometering data, which are obtained at a wide viewing angle before zooming up, a portion of the imaging conditions data corresponding to a “tele” (telephoto) viewing angle after zooming up, to thereby perform AF, AE, and/or AWB operations after zooming up. When the user pans the camera to shift the viewing angle out of the range of the original wide viewing angle, the data of an area of the image plane of the wide viewing angle closest to the image plane of a new post-panning viewing angle is reused. In a digital camera having a plurality of image capturing optical systems which are switched in response to a zoom position, data obtained by the pre-switching image capturing optical system is reused by a selected post-switching image capturing optical system.

### FIELD OF THE INVENTION

The present invention relates to an image capturing apparatus, and more particularly to focus control, exposure control, and/or white balance control performed by an image capturing apparatus.

### BACKGROUND OF THE INVENTION

Image capturing apparatuses, such as digital cameras, use a distance measuring sensor and a photometering sensor to detect a distance from and brightness of an object, in order to perform focus control (AF), exposure control (AE), and/or white balance control (AWB). Should a scene to be captured be unchanged, the cameras can hold and use such data for a predetermined time interval. To shoot different scenes, however, the AF and AE must be performed again for each scene to be captured.

Japanese Patent Laid-Open Publication No. Hei 8-9236 discloses that a user can arbitrarily change areas to perform AF and AE, wherein the AF and AE operations are prohibited during a transition of an area for acquiring image information, such as a focal point detecting area or a photometering area.

In the above prior art technique, although the AF and AE operations are prohibited during the transition of the focal point detecting area and the photometering area, once the transition is completed, the distance and brightness have to be measured again over the newly set focal point detecting area and photometering area. Thus, it takes time before image capturing is ready after the AF and AE operations have been completed. The transition of the focal point detecting area and the photometering area occurs frequently when a zoom lens is driven in response to a manipulation of a zoom button by the user, or when the user pans the camera to change the scene to be captured. It is a major problem, therefore, how quickly the AF and AE are performed after zooming or panning.

In addition, with a camera system having multiple image capturing optical systems, rather than a single optical system, which shoot an object by selectively switching the optical systems, again it takes time before image capturing is ready, if the distance and brightness are re-measured by the selected optical system to perform the AF and AE operations. This is also true for the automatic white balance adjustment (AWB) that predicts the light source of an object to correct tones according to the predicted light source.

### SUMMARY OF THE INVENTION

It is therefore an object of the present invention to provide an image capturing apparatus which is capable of performing the AF, AE, and/or AWB quickly and independently, irrespective of zooming/panning of the apparatus, or switching of image capturing optical systems.

The present invention provides an image capturing apparatus having a zoom lens, including user operation means for setting a zoom position; and control means for driving the zoom lens in accordance with a zoom position set through the user operation means and for performing focus control, exposure control, and/or white balance control. Of the imaging conditions data, including distance measuring data, photometering data, white balance data, or other data obtained at a pre-zooming viewing angle, the control means uses a portion of the imaging conditions data corresponding to a post-zooming viewing angle, in order to perform one of the focus control, the exposure control, and the white balance control at the post-zooming viewing angle.

In one embodiment of the present invention, when a zoom “up” (“in”) setting is selected by the user operation means, the control means use, of the imaging conditions data including the distance measuring data, the photometric data, and the white balance data obtained at a wide viewing angle before zooming up (in), a portion of the imaging conditions data corresponding to a “tele” (telephoto) viewing angle after zooming up, in order to perform the focus control, the exposure control, and/or the white balance control at the tele viewing angle.

The present invention also provides an image capturing apparatus including a first image capturing optical system, a second image capturing optical system having a different viewing angle from that of the first optical system, user operation means for setting a zoom position, and control means for selectively switching the first and second image capturing optical systems and for performing focus control, exposure control and/or white balance control. The control means uses, of the imaging conditions data, including distance measuring data, photometering data, white balance data, or other data obtained at a previous viewing angle of the pre-switching optical system, a portion of the imaging conditions data corresponding to a post-switching viewing angle of the selected optical system, in order to perform one of the focus control, the exposure control, and the white balance control for the selected optical system.

The present invention further provides an image capturing apparatus including user operation means for setting a zoom position, and control means for electronically zooming an image in response to the zoom position set through the user operation means. Of the imaging conditions data, including distance measuring data, photometering data, white balance data, or other data obtained at a previous viewing angle before the electronic zooming, the control means use a portion of the imaging conditions data corresponding to a viewing angle after the electronic zooming, in order to perform one of the focus control, the exposure control, and the white balance control at the viewing angle after the electronic zooming.

According to the present invention, while the camera is zoomed or panned, or when multiple image capturing optical systems are switched, the AF, AE and/or AWB are performed by using the pre-operation or pre-switching data, so that faster processing of the apparatus is allowed, and inappropriate exposure, such as over exposure and under exposure, which causes whiteness or blackness in the finished prints of the image, can be prevented.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a block diagram showing an embodiment of a digital camera;

FIG. 2 is a diagram for explaining a change from the wide viewing angle to the tele viewing angle;

FIGS. 3 and 4 are two views for explaining a change of the tele viewing angle, accompanied by panning of the camera;

FIG. 5 is a block diagram showing an another embodiment of a digital camera;

FIGS. 6A and 6B are two views for explaining the wide edge and the tele edge of the viewing angle of the first and the second image capture optical system, respectively;

FIG. 7 is a flow chart showing the process (to switch to the tele side) using multiple optical systems; and

FIG. 8 is a flow chart showing the process (to switch to the wide side) using multiple optical systems.

### DETAILED DESCRIPTION OF THE INVENTION

Embodiments of the present invention will be described with reference to the attached drawings.

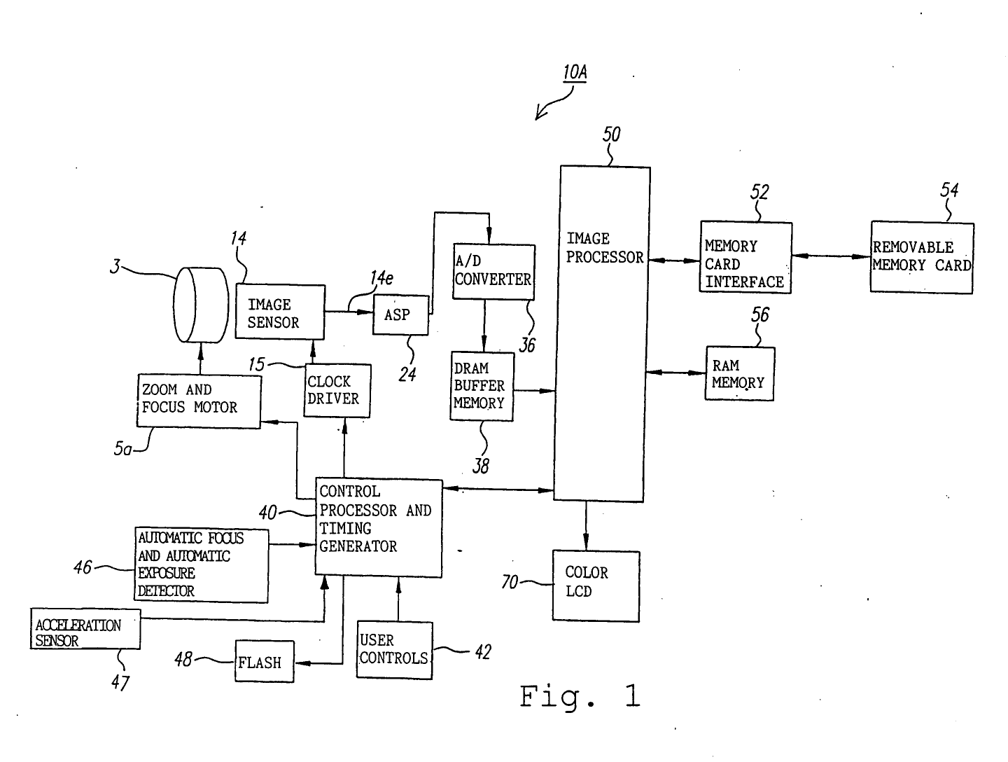

Referring to FIG. 1, there is shown a block diagram of a digital camera 10A having a single image capture optical system. The digital camera 10A is a battery-driven portable camera for producing digital still images which are stored on a removable memory card 54. The digital camera 10A may produce digital motion images with or in addition to the still images. The digital motion images are also stored on the memory card 54.

The digital camera 10A includes an image capture assembly including a zoom lens 3 which focuses an image of a scene on an image sensor 14. The zoom lens 3 is, for example, a “35 mm film equivalent focal length” of 40 mm-120 mm (hereinafter written as 40 mm-120 mm equiv.) zoom lens driven by a zoom and focus motor 5a. The zoom lens 3 includes an aperture and shutter assembly for controlling the exposure of the image sensor 14.

The image sensor 14 is a single chip color Megapixel CCD sensor using the well-known Bayer color filter pattern to capture color images. The image sensor 14 has a 4:3 image aspect ratio, for example with 2,048 active columns of pixels×1,536 active rows of pixels, for an effective total of 3.1 megapixels.

A control processor and timing generator 40 controls the image sensor 14 by supplying signals to a clock driver 15. The control processor and timing generator 40 also controls the zoom and focus motor 5a, and a flash 48 which is used to illuminate a scene to be captured. The control processor and timing generator 40 receives signals from an automatic focus and automatic exposure detector 46. Instead of using the automatic focus and automatic exposure detector 46, the image sensor 14 could be used to provide exposure detection and through-the-lens (TTL) autofocus. User controls 42 are used to control the operation of the digital camera OA. The control processor and timing generator 40 receives signals from an acceleration sensor 47 which detects the movement of the digital camera OA. In response to the signals received from the acceleration sensor 47, the control processor and timing generator 40 calculates a change of a viewing angle from a pre-zooming or pre-movement viewing angle to a post-zooming or post-movement viewing angle, to thereby control the AF, AE and/or white balance.

The analog output signals 14e from the image sensor 14 are amplified by an analog signal processor (ASP) 24 and provided to the input of an analog-to-digital converter 36. The digital data provided by the A/D converter 36 is stored in a DRAM buffer memory 38 and subsequently processed by an image processor 50. The processing performed by the image processor 50 is controlled by firmware stored in a firmware memory, which can be flash EEPROM memory. The processor 50 processes the input digital image file, which is buffered in a RAM memory 56 during the processing stage.

The digital image file processed in the image processor 50 is provided to a memory card interface 52 which stores the digital image file on the removable memory card 54. Removable memory cards 54 are one type of digital image storage medium, and are available in several different physical formats. For example, the removable memory card 54 can include memory cards adapted to well-known formats, such as the Compact Flash□, SmartMedia, Memory Stick, MMC, SD, or XD memory card formats. Other types of digital image storage formats, such as magnetic hard drive, magnetic tape, or optical disks can also be used. Alternatively, the digital camera 10A can use an internal non-volatile memory, such as internal Flash EPROM memory. In such an embodiment, the memory card interface 52 and the memory card 54 are not needed.

The image processor 50 performs various housekeeping and image processing functions, including color interpolation followed by color and tone correction, in order to produce rendered sRGB image data. The rendered sRGB image data is then JPEG compressed and stored as a JPEG image file on the removable memory card 54. The rendered sRGB image data may also be provided to a host PC via a host interface communicating over a suitable interconnection, such as a SCSI connection, a USB connection, or a Fire Wire connection. The JPEG file uses the so-called “Exif” image format.

It should be noted that the image processor 50, while typically a programmable image processor, can alternatively be a hard-wired custom integrated circuit (IC) processor, a general purpose microprocessor, or a combination of hard-wired custom IC and programmable processors.

The image processor 50 also creates a low-resolution “thumbnail” size image. After images are captured, thumbnail size images are displayed on a color LCD 70. The graphical user interface displayed on the color LCD image display 70 is controlled by the user controls 42.

In the above-mentioned configuration, when a user manipulates the zoom button of the user controls 42 to zoom up the image being captured, and when a user pans the digital camera 10A in order to change the object to be captured, the processing described below will be performed.

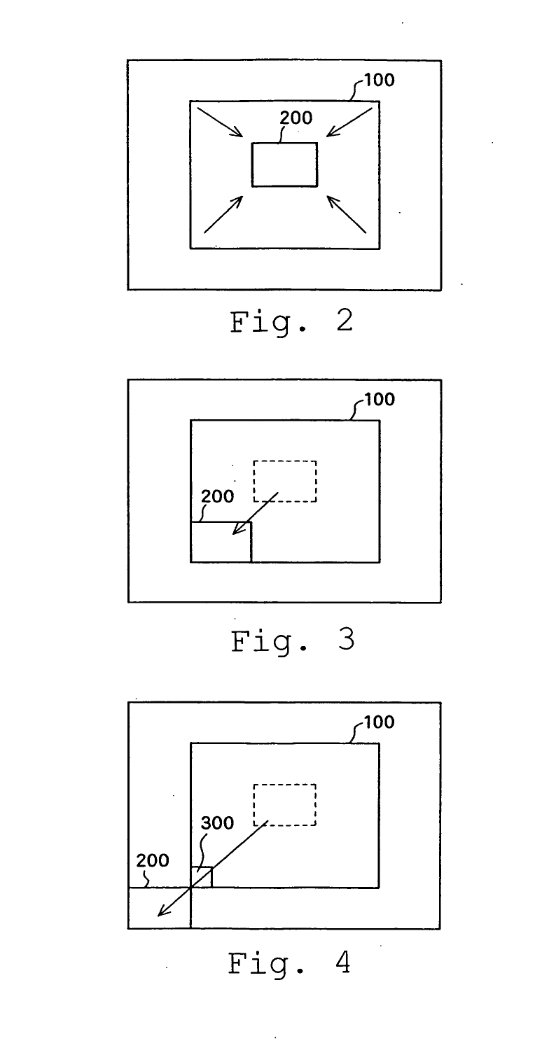

FIG. 2 shows a transition of the image plane in response to the transition of the viewing angle when the user operates the zoom button toward a tele side to zoom up (in). As shown in FIG. 2, as the viewing angle changes from a pre-zoom up wide viewing angle to a post-zoom up tele viewing angle, the image plane changes from 100 to 200. If the post-zoom up image plane for the tele viewing angle 200 lies within the range of the pre-zoom up image plane for the wide viewing angle 100, distance measuring data and photometering data obtained by the automatic focus and automatic exposure detector 46 in the pre-zoom up image plane for the wide viewing angle 100 can be reused directly without modification. More specifically, a plurality of focal point detecting areas are predetermined in the wide angle image plane 100 and, if any of these predetermined focal point detecting areas matches, or partially overlaps, the position of the post-zoom up tele image plane 200, it is possible to reuse, in an unprocessed manner, the distance measuring data of that area for the image plane of the tele viewing angle 200. In the meantime, a plurality of photometering areas are also predetermined in the wide angel image plane 100 and, if any of these predetermined photometering areas matches, or partially overlaps, the position of the post-zoom up tele image plane 200, the photometering data of that area can be reused in an unprocessed manner for the image plane of the tele viewing angle 200. Similarly, as to the white balance control, the image plane for the wide viewing angle 100 are divided into plural segments, in order to predict a light source and, by using the predicted light source of the area corresponding to the position of the tele image plane 200, the white balance control is performed over the image plane of the tele viewing angle.

For example, the AE control will be performed as follows. Image signals from the wide angle image plane 100 are stored in a memory, such as the DRAM 38. In the DRAM 38, the image signals from the wide angle image plane 100 are repeatedly updated and stored regularly at a predetermined time interval, but when the user moves the zoom button to the tele side, the rewrite of the DRAM 38 is interrupted. The control processor and timing generator 40 predicts a shooting range of the zoom lens 3, i.e., the viewing angle of the zoom lens 3, in response to the information of the zoom lens, such as a focal length of the zoom lens. Once a zooming operation is completed, the image signals corresponding to the tele angle image plane 200 created by the zoom lens 3 are cropped or extracted from the DRAM 38 and, simply based on the cropped image signals, an appropriate exposure is calculated. Thus, the AE control is performed in the tele viewing angle in response to the calculated appropriate exposure.

The positional relationship of image planes as shown in FIG. 2, i.e. whether or not the image plane of the tele viewing angle 200 lies within the image plane of the wide viewing angle 100, is determined in response to a detection signal from the acceleration sensor 47. If the acceleration detected by the acceleration sensor 47 is equal to or less than a predetermined value, indicating no substantial movement of the digital camera 10A, then the control processor and timing generator 40 determines that the image plane of the tele viewing angle 200 lies within the range of the image plane of the wide viewing angle 100. After determined as such, it is then determined whether or not the distance measuring data, the photometering data, and/or the white balance data obtained in the wide viewing angle 100 can be reused. This is accomplished in a similar manner to that described above by judging whether or not the data of an area of the image plane of the wide viewing angle 100 corresponding to the image plane of the tele viewing angle 200 is available, i.e., whether or not there is an area of the image plane of the wide viewing angle 100, that matches or at least partially overlaps the image plane of the wide viewing angle 100. If the data is reusable, the AF, AE and/or AWB can be performed in the tele viewing angle 200 using such reusable data. If the reusable data is not available, the distance measuring data and other data will be acquired again in the tele viewing angle 200. Note that in the case where the reusable data is not available, the data of other areas of the image plane of the wide viewing angle 100 located in the vicinity of the image plane of the tele viewing angle 200 could be reused, which will be described later. It should also be noted that, instead of using the detection signals from the acceleration sensor 47, the determination of whether or not the image plane of the tele viewing angle 200 lies within the image plane of the wide viewing angle 100 may be accomplished by image matching or a correlation operation of the images of the wide viewing angle 100 and the tele viewing angle 200. Alternatively, a combination of the detection signals from the acceleration sensor 47 and the image matching may be used. For instance, if the detected acceleration is equal to or less than a predetermined value, the process is transferred to image matching to identify an area of the image plane of the wide viewing angle 100 corresponding to the image plane of the tele viewing angle 200. Alternatively, it may also be possible to calculate a frame-to-frame correlation to detect a direction and a distance of movement of the digital camera 10A, to thereby predict the positional relationship of the image planes of the wide viewing angle 100 and the tele viewing angle 200.

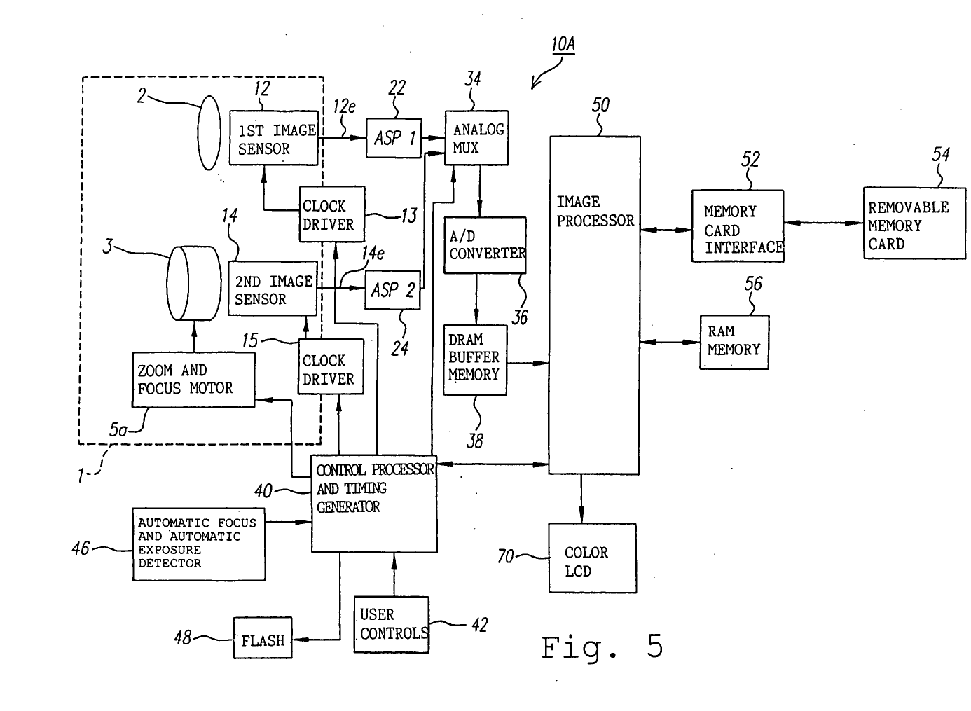

FIGS. 3 and 4 show a transition of the image plane when the user performs a zoom up to the tele viewing angle and pans the digital camera 10A. Referring to FIG. 3, the image plane of the tele viewing angle 200 remains within the image plane of the wide viewing angle 100 after panning. Whether or not the image plane of tele viewing angle 200 lies within the image plane of the wide viewing angle 100 after panning is judged in response to the detection signal from the acceleration sensor 47. More specifically, a transition amount of the image plane of the tele viewing angle is predicted in response to the detection signal from the acceleration sensor 47, in order to determine whether or not the image plane of the tele viewing angle 200 lies within the image plane of the wide viewing angle 100. If the image plane of the tele viewing angle 200 lies within the image plane of the wide viewing angle 100, as shown FIG. 2, the distance measuring data, the photometering data, and/or the white balance data obtained in an area of image plane of the wide viewing angle 100 corresponding to the image plane of the tele viewing angle 200 are reused to perform the AF, AE and/or AWB.

For example, the AE is performed as follows. The image signals obtained from the image plane of the wide viewing angle 100 are stored in the memory, such as the DRAM 38. When the acceleration sensor 47 detects that the digital camera 10A is moved, a range of the image plane of the tele viewing angle 200 is predicted according to a direction and a distance of movement of the digital camera 10A, to thereby crop from the DRAM 38 the image signals of an area corresponding to the image plane of the tele viewing angle 200 and calculate an appropriate exposure. Thereupon, the AE is performed in the image plane of the tele viewing angle 200 in response to the resultant appropriate exposure.

In the meantime, as shown in FIG. 4, if the image plane of the tele viewing angle 200 lies beyond the range of the image plane of the wide viewing angle 100 after panning the camera, the distance and brightness may be re-measured. Instead, it is preferable to reuse, in an unprocessed manner, the distance measuring data or the photometering data of an area 300 of the image plane of the wide viewing angle 100, which is located closest to the image plane of the tele viewing angle 200 after panning the camera. Whether the data is used in a processed or unprocessed manner is determined depending on the distance between the image plane of the tele viewing angle 200 and the image plane of the wide viewing angle 100. Specifically, if the area 300 of the image plane of the wide viewing angle 100, which is located closest to the image plane of the tele viewing angle 200, lies within a predetermined distance from the image plane of the tele viewing angle 200, the data of the area 300 is reused directly, while the data could be processed if the distance exceeds the predetermined value. Any method may be used for processing the data, such as multiplying a predetermined coefficient with the distance measuring data or the photometering data of the area 300. It should also be noted that if the area 300 is farther apart from the image plane of the tele viewing angle 200, it is preferable to re-measure the distance and brightness, rather than reusing the data of the area 300.

The above-mentioned process is the zoom up process, and similar operations will be carried out when a user manipulates the zoom button toward a wide side in order to zoom “down” (“out”). For example, referring again to FIG. 2, if the image plane of the tele viewing angle 200 is zoomed down to the image plane of the wide viewing angle 100, the distance measuring data and the photometering data obtained from the image plane of the tele viewing angle 200 could be reused in an unprocessed manner for the image plane of the wide viewing angle 100.

The data to be reused for the zoom up and the data to be reused for the zoom down are predetermined selectively, where different types of data may preferably be assigned to the zoom up and the zoom down, respectively.

For example, as to the AWB, because the prediction of a light source could be done more accurately in the wide viewing angle rather than in the tele viewing angle, the white balance data obtained in the image plane of the wide viewing angle 100 is reused in the image plane of the tele viewing angle 200 directly for zooming up, while the white balance data of the image plane of the tele viewing angle 200 is not reused for zooming down. Other data, such as the distance measuring data, could be reused for the zoom down.

In this embodiment, the data obtained from the image plane of the wide viewing angle 100 is reused in the image plane of the tele viewing angle 200, and vice versa, to avoid a time delay related to the re-measurement of the distance and brightness, while preventing resultant images from being white due to over exposure, or being black due to under exposure.

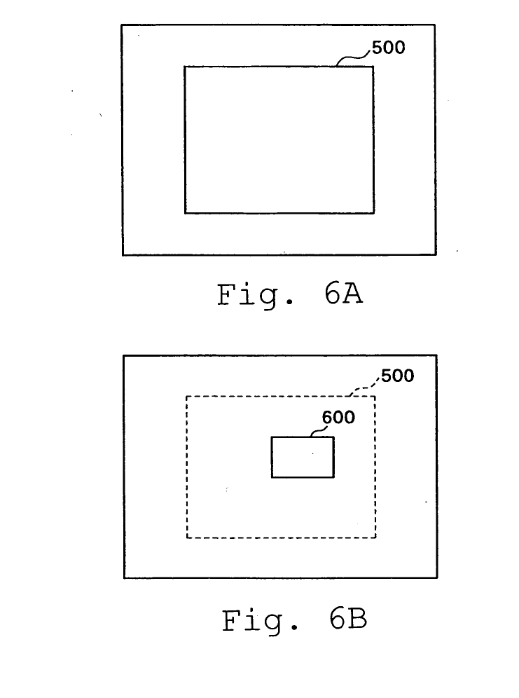

FIG. 5 is a block diagram showing the configuration of a digital camera 10A having two image capture optical systems. The digital camera 10A includes an image capture assembly 1, which includes a fixed focal length lens 2 which produces an image of a scene to be captured on a first image sensor 12, and a zoom lens 3 which focuses an image of the scene on a second image sensor 14. The image capture assembly 1 provides a first image output 12e from the first image sensor 12 and a second image output 14e from the second image sensor 14. The image sensors 12 and 14 have the same aspect ratio and pixel size, where the lens 2 is an ultra wide angle lens of a 35 mm equiv. film size of 22 mm, and the zoom lens 3 is a 40 mm-120 mm equiv. zoom lens.

The focal length of the fixed focal length lens 2 provides a 22 mm ultra wide field of view, so that objects from 4 feet to infinity are in focus. Therefore, the fixed lens 2 does not need to include a focus adjustment. The fixed focal length lens 2 includes an aperture and shutter assembly to control the exposure of the image sensor 12. The zoom lens 3 is controlled by zoom and focus motors 5a and an aperture and shutter assembly to control the exposure of the image sensor 14.

The image sensors 12, 14 are single chip color Megapixel CCD sensors using the well-known Bayer color filter pattern to capture color images.

A control processor and timing generator 40 controls the first image sensor 12 by supplying signals to a clock driver 13 and controls the second image sensor 14 by supplying signals to a clock driver 15. The control processor and timing generator 40 also controls a zoom and focus motor 5a, and a flash 48 which is used to illuminate a scene to be captured. The control processor and timing generator 40 receives signals from an automatic focus and automatic exposure detector 46. Instead of using the automatic focus and automatic exposure detector 46, the image sensor 14 could be used to provide exposure detection and TTL autofocus. User controls 42 are used to manipulate the digital camera 10A.

The analog output signals 12e from the first image sensor 12 are amplified by a first analog signal processor (ASP 1) 22 and provided to a first input of a control element 34, i.e., an analog multiplexer control element. The analog output signals 14e from the second image sensor 14 are amplified by a second analog signal processor (ASP 2) 24 and provided to a second input of the control element 34. The function of the control element 34 is to select either the first sensor output 12e from the first image sensor 12 or the second sensor output 14e from the second image sensor 14, thereby providing a selected sensor output from the image capture assembly 1 to the components in the subsequent stage.

The control processor and timing generator 40 controls the analog multiplexer control element 34 in order to provide the output of either the (ASP 1) 22 or the (ASP 2) 24 to an A/D converter circuit 36. The digital data provided by the A/D converter 36 is stored in a DRAM buffer memory 38 and subsequently processed by an image processor 50. The processing performed by the image processor 50 is controlled by firmware stored in a firmware memory, which can be flash EEPROM memory. The processor 50 processes the input digital image file, which is buffered in a RAM memory 56 during the processing stage.

An alternative configuration is also available where the two A/D converter circuits are connected to the output of the first and second signal processors (ASP1) 22 and (ASP2) 24, respectively. In this configuration, the analog MUX 34 is not needed. Instead, a digital multiplexer is used to select either output of the two A/D converter circuits.

The digital image files processed in the image processor 50 are provided to the memory card interface 52, which stores the digital image files on the removable memory card 54.

In this configuration, when the user manipulates the zoom button of the user controls 42 toward the tele side, the images produced by the first image capture optical system, including the fixed focal length lens 2 and the first image sensor 12, are selected and displayed on the LCD 70 display. The images include, depending on the zoom position, from an image captured at the wide edge of the electronic zoom to various zoomed images created by the electronic zoom. When the zoom position reaches the tele edge of the electronic zoom, the image capture optical system is switched from the first image capture optical system to the second image capture optical system formed by the zoom lens 3 and the second image sensor 14, and the LED 70 displays optically zoomed images produced by the zoom lens 3. When the zoom up is performed over the images of the first image capture optical system, as in the above mentioned embodiment, it is possible to quickly perform the AF, AE, and/or AWB by reusing the distance measuring data, photometering data, and white balance data obtained in the image at the wide edge in an unprocessed manner. In the meantime, however, if the optical system is switched from the first image capture optical system to the second image capture optical system, the distance and brightness need to be re-measured.

Therefore, in this embodiment, when the first optical system is switched to the second optical system, or vice versa, depending on the zoom position, the data used in the previous optical system can be reused in an unprocessed, or alternatively, processed manner in the selected optical system.

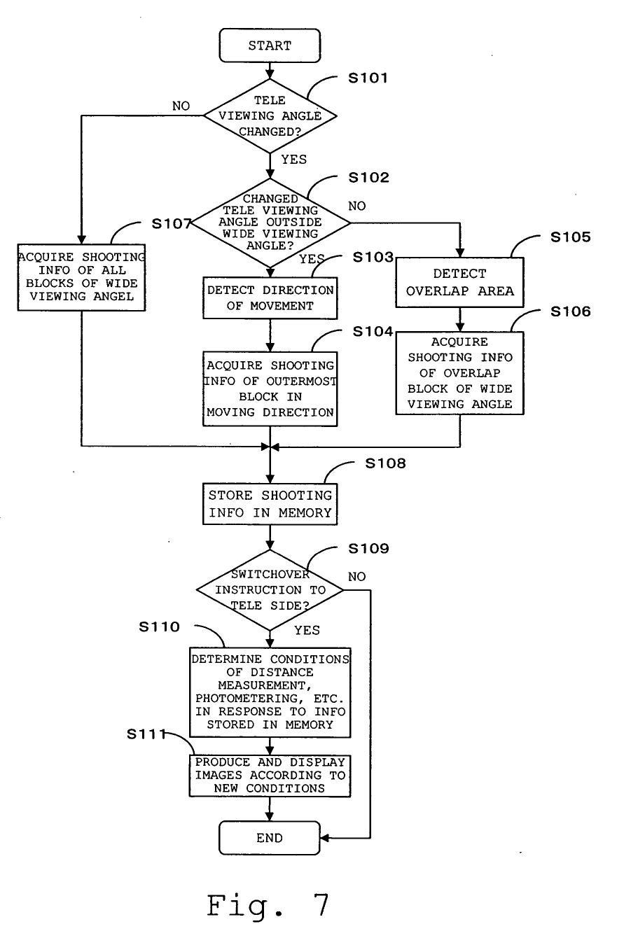

FIGS. 6A and 6B show an image plane of the wide edge viewing angle 500 obtained by the first image capture optical system, and an image plane of the viewing angle 600 obtained by the second image capture optical system, respectively, which are provided when the user manipulates the zoom button toward the tele side to zoom up. When the optical paths of both optical systems extend substantially in parallel, the image plane of the viewing angle 600 lies within the image plane of the viewing angle 500. Therefore, the control processor and timing generator 40 changes the image capture optical system from the first image capture optical system to the second image capture optical system, and reuses the data of an area of image plane of the angel of view 500 corresponding to the image plane of the viewing angle 600 directly in an unprocessed manner, or alternatively, by processing the data in response to the optical characteristics of the lenses 2 and 3, to thereby perform the AF, AE and/or AWB of the second image capture optical system. Similarly, when the viewing angle of the second image capture optical system is not fixed and can be set arbitrarily by the user, after setting the position of the viewing angle of the second image capture optical, an area of the image plane of the viewing angle 500 corresponding to the image plane of the viewing angle 600 is identified, and the data of that area is reused. After switching from the first optical system to the second optical system, if it is desired to conserve power consumption by cutting the power source of the first image capture optical system, the power source of the first image capture optical system could be turned off after determining the area of image plane of the viewing angle 500 corresponding to the image plane of the viewing angle 600 and identifying the reusable data.

For example, the AE will be performed as follows. Image signals acquired by the first image capture optical system are repeatedly stored and updated in the DRAM. When the zoom position reaches a position where the first image capture optical system needs to be switched to the second image capture optical system, the rewrite of the DRAM is interrupted. After switching the optical system, the control processor and timing generator 40 predicts a shooting range of the zoom lens 3, or the viewing angle 600, in response to the focal length information of the zoom lens 3, and at the end of zooming, retrieves from the DRAM the image signals of the area corresponding to the viewing angle 600, to thereby calculate the appropriate exposure. Then the AE is performed in response to the resultant appropriate exposure of the tele viewing angle.

Alternatively, if the positional relationship between the viewing angle of the first image capture optical system and the viewing angle (i.e., the wide edge of the viewing angle) of the second image capture optical system is known, the image signals of an area of the image plane of the viewing angle of the first optical system corresponding to the image plane of the viewing angle of the second optical system could be extracted immediately before switching from the first to the second optical system, in order to calculate the appropriate exposure (by considering the optical characteristics of the second optical system) in advance for the second optical system. The control processor and timing generator 40 continues to calculate the AE data for the first optical system until the zoom position reaches the vicinity of the switching zoom position and, when the switching zoom position is reached, additionally calculates in advance and stores the AE data for the second optical system by using the image signals of a predetermined area. After switching the optical system, the control processor and timing generator 40 performs the AE using the pre-calculated appropriate exposure for the second optical system.

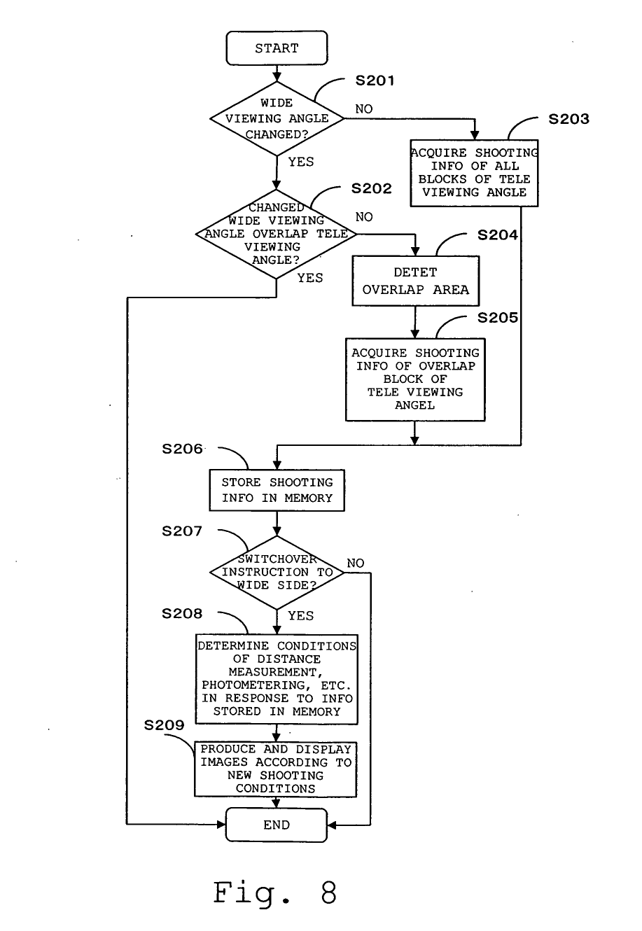

FIG. 7 is a flow chart showing the zoom up process. Firstly, whether or not the tele viewing angle 600 is changed is determined in response to a detection signal from the acceleration sensor 47 (S101). If the tele viewing angle 600 is unchanged, the image capturing information (AF, AE and AWB) are acquired over the entire area (i.e., all blocks) of the image plane of the wide viewing angle 500 (S107). On the contrary, if the tele viewing angle 600 is changed, it is then determined whether or not the new tele viewing angle is within the range of the wide viewing angle 500 (S102). If the tele viewing angle 600 is within the range of the wide viewing angle 500 (i.e., a no response to S102), which portion of the image plane of the wide viewing angle 500 overlaps is detected (S105) to acquire the image capturing information of the overlap portion of the image plane of the wide viewing angle 500 (S106). Alternatively, if the new tele viewing angle 600 is outside the range of the viewing angle 500 (i.e., a yes response to S102), a direction of movement is detected in response to the detection signal from the acceleration sensor 47 (S103), to acquire the image capturing information of the outermost block of the image plane of the wide viewing angle 500 in the direction of movement (S104). The thus acquired image capturing information is stored in a memory of the control processor 40 (S108). Then, it is determined whether or not a switchover instruction from the first to the second image capture optical system (i.e., an instruction to switch to the tele side) is received (S109). If the switchover instruction is received, the conditions for measuring the distance, brightness, etc. are determined in response to the image capturing information of the wide viewing angle 500, which has been stored in the memory in S108 (S110). Then, an image is captured according to the determined shooting conditions, and the captured image is displayed on the LCD 70 and stored on the memory card 54 (S111). If there is no instruction to switch to the tele side, the image capturing conditions stored in the memory will not be used.

FIG. 8 is a flow chart showing the zoom down process. Firstly, whether or not the wide viewing angle 500 is changed is determined in response to a detection signal from the acceleration sensor 47 (S201). If the wide viewing angle 500 is not changed, the image capturing information (AF, AE and AWB) are acquired over the entire area (i.e., all blocks) of the image plane of the tele viewing angle 600 (S203). On the contrary, if the wide viewing angle 500 is changed, it is then determined whether or not the new wide viewing angle overlaps the range of the tele viewing angle 600 (S202). If the wide viewing angle 600 overlaps the range of the tele viewing angle 600 (i.e., a no response to S202), the overlap portion of the image planes of the wide and tele viewing angles 500 and 600 is identified (S204) and the image capturing information of the overlap portion of the image plane of the tele viewing angle 600 is acquired (S205). In the meantime, if the new wide viewing angle 600 is outside the range of the tele viewing angle 500 (i.e., a yes response to S202), the image capturing information of the image plane of the tele viewing angle 600 is not acquired, because such information is not reusable. The acquired image capturing information is stored in the memory of the processor (S206). Then, it is determined whether or not a switchover instruction from the second to the first image capture optical system (i.e., an instruction to switch to the wide side) is received (S207). If the switchover instruction is received, the conditions for measuring the distance, brightness, etc. are determined in response to the image capturing information of the tele viewing angle 600, which has been stored in the memory in S206 (S208), and an image is captured in response to the determined shooting conditions (S209). If there is no switchover instruction to the wide side, the image capturing conditions stored in the memory is not reused.

In the digital camera 10A having multiple optical systems, as described in this embodiment, it may be possible to continuously supply power to the multiple image capture optical systems so as to keep all the systems in an active state. In this case, if the image capture optical system is switched from the first system to the second system, it would not be necessary to reuse the data used in the first optical system, because the second optical system continuously holds and updates the data for the AF, AE and/or AWB. However, as mentioned above, in the battery-driven portable digital camera 10A, it is preferable to shut down the power source of the optical system while it is not being used. In this respect, reusing the data acquired by the previous image capture optical system is an effective and advantageous way to reduce the time needed for switching the optical system.

It should also be noted that since the second image capture optical system of this embodiment has the zoom lens 3, when the zoom lens 3 is zoomed up or zoomed down, or the camera is panned, the pre-zooming data could also be reused after zooming, as in the process of the above described system with a single image capture optical system.

It should further be noted that although a combination of the fixed focal length lens 3 and the zoom lens 3 is illustrated in FIG. 5, it is not intended that the present invention be limited to this arrangement and a combination of different types of zoom lens may also be used or, alternatively, three or more image capture optical systems could be used.

It should still further be noted that although the zoom lens 3 is used in the first embodiment, a fixed focal length lens may alternatively be used. With a fixed focal length lens, the zoom up feature is implemented by an electronic zoom for zooming the images produced on the second image sensor 14. Typical electronic zooms simply enlarge and interpolate an original image. However, this invention provides the electronic zoom feature which acquires the image capturing information of the entire area (all blocks) of an original image (i.e., an original image of the wide viewing angle 100) and stores the information in the memory, and when a magnification of the electronic zoom reaches a predetermined value, such as ×2, ×3, or ×4, the image capturing information of a corresponding area (or block) of the original image is read from the memory, as a result of which the electronically zoomed images are updated using the retrieved image capturing information (namely the photometering data). As such, appropriate exposure similar to that of the original image is ensured for the electronic zoom. This procedure is also applicable to the zoom down process. For example, if the magnification of the electronic zoom is reduced from ×4 to ×2, the image capturing information of the corresponding block of the original image (i.e., the original image of the wide viewing angle 100) is read from the memory to update the electronically zoomed image using the retrieved image capturing information. Alternatively, during the zoom down, the original image itself may be corrected manually by the user by reflecting the image data, such as the exposure data, of the updated electronically zoomed image in the original image. If the camera uses the zoom lens 3 instead of the fixed focal length lens, the electronic zoom is also needed at and beyond the tele edge, where the electronically zoomed image could be updated using the image capturing information of the original image (i.e., the image obtained at the optical tele edge of the focal length of the zoom lens 3).

What is claimed is:

1. An image capturing apparatus having a zoom lens, comprising:
user operation means for setting a zoom position; and
control means for driving the zoom lens in accordance with the zoom position set through the user operation means, and
for performing focus control, exposure control, and/or white balance control, wherein
the control means uses a portion of imaging conditions data including distance measuring data, photometering data, white balance data, or other data obtained at a viewing angle before a zooming operation,
said portion of the imaging conditions data corresponding to a viewing angle after the zooming operation,
to perform at least one of the focus control, the exposure control, and the white balance control at the viewing angle after the zooming operation.

2. An image capturing apparatus according to claim 1, wherein when a zoom in setting is selected by the user control means,
the control means uses, a portion of the distance measuring data, the photometering data and the white balance data obtained at a wide viewing angle before zooming in,
corresponding to a tele (telephoto) viewing angle after zooming in,
to thereby perform the focus control, the exposure control, and/or the white balance control at the tele viewing angle.

3. An image capturing apparatus according to claim 2, further comprising:
detection means for detecting a movement of the image capturing apparatus,
wherein the control means extracts a portion of the data corresponding to the tele viewing angle in response to a detection signal from the detection means.

4. An image capturing apparatus according to claim 1, wherein when the zoom in setting is selected by the user control means,
the control means uses a portion of the distance measuring data, the photometering data and the white balance data obtained at the wide viewing angle before zooming in,
obtained in an area of an image plane of the wide viewing angle located closest to an image plane of the tele viewing angle after zooming in,
to thereby perform the focus control, the exposure control, and/or the white balance control at the tele viewing angle.

5. An image capturing apparatus according to claim 1, wherein the control means use different types of data at the viewing angle after the zooming operation, depending on whether the user control means selects the zoom in setting or the zoom out setting.

6. An image capturing apparatus, comprising:
a first image capturing optical system;
a second image capturing optical system having a different viewing angle from the viewing angle of the first image capturing optical system;
user control means for setting a zoom position; and
control means for selectively switching the first and second image capturing optical systems depending on the zoom position set through the user control means and, after switching the image capturing optical systems, for performing focus control, exposure control, and/or white balance control of the selected image capturing optical system, wherein
the control means uses a portion of imaging conditions data including distance measuring data, photometering data, white balance data, or other data obtained at a viewing angle of a pre-switching image capturing optical system,
said portion of the imaging conditions data corresponding to a viewing angle of the selected image capturing optical system,
to thereby perform one of focus control, exposure control and white balance control for the selected post-switching image capturing optical system.

7. An image capturing apparatus according to claim 6, wherein
the first image capturing optical system includes a fixed focal length lens,
the second image capturing optical system includes a zoom lens having a narrower viewing angle than that of the fixed focal length lens, and
the control means uses a portion of the imaging conditions data including the distance measuring data, the photometering data, the white balance data, and other data obtained at a wide viewing angle set through the pre-switching first image capturing optical system,
said portion of the imaging conditions data corresponding to a tele viewing angle set through the selected post-switching second image capturing optical system,
to thereby perform one of the focus control, the exposure control, and the white balance control at the tele viewing angle.

8. An image capturing apparatus, comprising:
user control means for setting a zoom position,
control means for electronically zooming an image in accordance with the zoom position set through the user control means, wherein
the control means uses a portion of imaging conditions data including distance measuring data, photometering data, white balance data, and other data obtained from the image prior to the electronic zooming,
said portion of the imaging conditions data corresponding to a viewing angle after the electronic zooming,
to thereby perform one of focus control, exposure control, and white balance control at the viewing angle after the electronic zooming.

9. An image capturing apparatus according to claim 6, wherein the control means uses the imaging conditions data by correcting the data in accordance with a difference of characteristic between the first and second image capturing optical systems.
